(19) United States
(12) Patent Application Publication
(10) Pub. No.: US 2007/0155344 A1
(43) Pub. Date: Jul. 5, 2007

(54) WIRELESS MULTIMODE CO-BAND RECEIVER DEVICE AND METHOD EMPLOYING RECEIVER BYPASS CONTROL

(75) Inventors: Randy A. Wiessner, Palatine, IL (US); Arthur C. Leyh, Spring Grove, IL (US)

Correspondence Address: VEDDER PRICE KAUFMAN & KAMMHOLZ, 222 N. LASALLE STREET, CHICAGO, IL, 60601, US

(73) Assignee: MOTOROLA, INC., Schaumburg, IL (US)

(21) Appl. No.: 11/306,479

(22) Filed: Dec. 29, 2005

(51) Int. Cl. H04B 1/44

(52) U.S. Cl. 455/78

(57) ABSTRACT

A wireless multimode radio access technology (RAT) handheld device (100) utilizes first and second wireless radio access technology receivers (108 and 110) includes at least one shared receiver component (120 or 121 or 123) that is within a shared receive path that is shared by both the different RAT receivers (108 and 110) when in a multimode receiver operation. The handheld device (100) includes a radio access technology bypass switch (106) and corresponding logic (112), that controls the RAT bypass switch to bypass the at least one receiver component (120 or 121 or 123) that is shared between the first and second RAT receivers (108 and 110), when the handheld device is in a single RAT receive mode of operation. A method is also disclosed that includes determining (202) if a single RAT receive mode of operation or a multi-RAT receive mode of operation is desired. The method also includes bypassing (204) at least one shared receiver component from a receive path for a corresponding RAT receiver used for the single mode of operation.

### BACKGROUND OF THE INVENTION

The present invention relates generally to wireless communication devices and methods and more particularly to multimode communication devices that have at least two receivers.

The emergence of third generation (3G) and higher mobile wireless communications systems creates a need for wireless communications devices capable of accessing multiple communications systems with different radio access technologies, for example, GSM and WCDMA communications systems serving a common geographical area. Known handheld wireless devices such as cell phones or any other suitable devices may use a shared receiver architecture to receive WCDMA signals and GSM signals which may be in the same frequency band so that the device provides wireless multimode radio access technology (RAT) connections. Such architectures may utilize, among other things, a signal splitter that provides received information into first and second signals that are received by each of a first RAT receiver (e.g. WCDMA receiver) and second RAT receiver (e.g. GSM receiver). However, while such components may allow co-banding receiver requirements to be met, they can degrade sensitivity and increase current drain and hence power consumption as compared to devices that only employ a single radio access technology receiver.

Also, known mobile stations or other wireless communication devices that employ multimode co-band receivers share a common receiver path for both types of radio access technology receivers. Accordingly, when, for example, there is no WCDMA signal available, the GSM receiver still uses the shared signal path and components in the shared receive path and can unnecessarily cause current drain and performance degradations.

For example, a wireless multimode radio access technology handheld device may include an antenna and a front end transmit/receive switch which, in a transmit mode, switches different RAT transmitters to the antenna when the device is transmitting information and switches to a common receive path for multiple RAT receivers when the device is in a receive mode. As known in the art, the front end switch module outputs received signals to a shared signal receive path that includes a 3G duplexer that may be required, for example, for WCDMA signals. The duplexer outputs the received signal to a low noise amplifier (LNA) which is controlled by a suitable processor. The output of the low noise amplifier is coupled to a splitter, which as used herein includes couplers or other suitable devices that provides a signal for first RAT receiver such as a WCDMA receiver and to a second RAT receiver such as a GSM receiver. In this manner, the handheld device can simultaneously receive multimode co-band signals from different RAT base stations. These different RAT receivers are also coupled to the processor so that the processor may suitably control these receivers as known in the art. As noted above, when no WCDMA signal is received, the duplexer nonetheless is still in the shared receive path as well as the low noise amplifier and splitter. These components can degrade the performance of the GSM receiver and/or consume current unnecessarily thereby reducing the life of the battery in the handheld device.

Although multimode co-band receivers are known that employ simultaneous reception using different radio access technology receivers such as GSM and WCDMA receivers, since the signals may be in the same frequency band, sharing for example a splitter may result in some loss of receiver sensitivity. This can be overcome, for example, by adding more gain to one of the channels, but the additional current draw may decrease battery life of the handheld device. If the handheld device is still in a dual RAT receive mode but the device is only receiving signals from one of the multimode base station transmitters, losses due to the operation of a low noise amplifier and splitter may be incurred since only one radio access technology receiver is receiving suitable signals.

Also, multimode handheld devices that utilize different RAT receivers may allow for individual RAT reception but do not typically employ simultaneous receive capabilities so such devices may be slower in handoff and cell selection operations. Other solutions may include the use of multiple antennas and dedicated RAT receivers but this can result in extra costs and increase in size of the device.

Accordingly, a need exists for a method and apparatus that overcomes one or more of the above drawbacks.

### BRIEF DESCRIPTION OF THE DRAWINGS

The invention will be more readily understood in view of the following description when accompanied by the below figures and wherein like reference numerals represent like elements:

FIG. 1 is a block diagram illustrating one example of a portion of a wireless multimode radio access technology handheld device in accordance with one embodiment of the invention;

FIG. 2 is a flowchart illustrating one example of a method in accordance with one embodiment of the invention;

FIG. 3 is a flowchart illustrating one example of a method in accordance with one embodiment of the invention; and

FIG. 4 is a block diagram illustrating another example of a wireless multimode radio access technology handheld device in accordance with one embodiment of the invention.

### DETAILED DESCRIPTION OF THE PRESENT EMBODIMENTS

Briefly, a wireless multimode radio access technology (RAT) handheld device that utilizes first and second wireless radio access technology receivers includes at least one shared receiver component that is shared between the first and second wireless radio access technology receivers during a multimode receive mode of operation. Shared receiver components may include, for example, a 3G duplexer, low noise amplifier (LNA), splitter (i.e., coupler), or any other shared component that is, for example, within a shared receive path that is shared by both the different RAT receivers when in a multimode receiver operation. The handheld device includes a radio access technology bypass switch and corresponding logic, that controls the RAT bypass switch to bypass the at least one receiver component that is shared between the first and second RAT receivers, when the handheld device is in a single RAT receive mode of operation.

In one embodiment, a first mode may be, for example, a GSM only mode and provides for the GSM receiver circuitry to be connected directly to a front end switch module and a co-band low noise amplifier that is in a shared receiver path may be disabled and bypassed. A second mode (e.g., a multi-RAT receive mode) may be a shared WCDMA and GSM mode where the two receive paths of the radio access technology receivers have a shared portion that passes signals from the front end switching structure through the 3G duplexer, LNA and splitter. The mode of operation may be selected dynamically depending upon what operations the multi radio access technology handheld device is required to perform.

Therefore in one example, a wireless multimode RAT handset is disclosed that employs, for example, a GSM receiver and a WCDMA receiver and utilizes a switching structure to bypass a 3G duplexer, low noise amplifier and splitter when operating in the GSM mode. As a result, GSM performance may be improved and power consumption may be improved when in the GSM mode, compared to devices that provide multimode receiver operation. Accordingly, the device has the flexibility to select between a co-band architecture or a single band architecture with, for example, a switching structure in a RAT receive path.

In addition, a method is disclosed that includes determining if a single RAT receive mode of operation or a multi-RAT receive mode of operation is desired. In one embodiment this is done automatically by determining a desired receive mode based on received information that is received, for example, via the first and second radio access technology receivers. If a suitable signal is not received by one RAT receiver then a single RAT receive mode is entered. The method includes bypassing the at least one shared receiver component from a receive path for a corresponding RAT receiver used for the single mode of operation. In one example this is done by controlling a RAT bypass switch and antenna transmit/receive switch to provide a separate receive path for the single RAT receiver mode of operation.

The method may include disconnecting the first RAT receiver and connecting the second RAT receiver to the antenna to receive the incoming signal from the corresponding RAT transmitter (base station). In addition to bypassing a low noise amplifier, for example, the power to the low noise amplifier may also be controlled either directly by removing power or by putting the LNA in a tri-state mode to reduce current draw. In addition, the handheld device may transmit power control information to a RAT base station transmitter in response to bypassing the shared receiver component to control a power level of the incoming signal that is received by the connected RAT receiver.

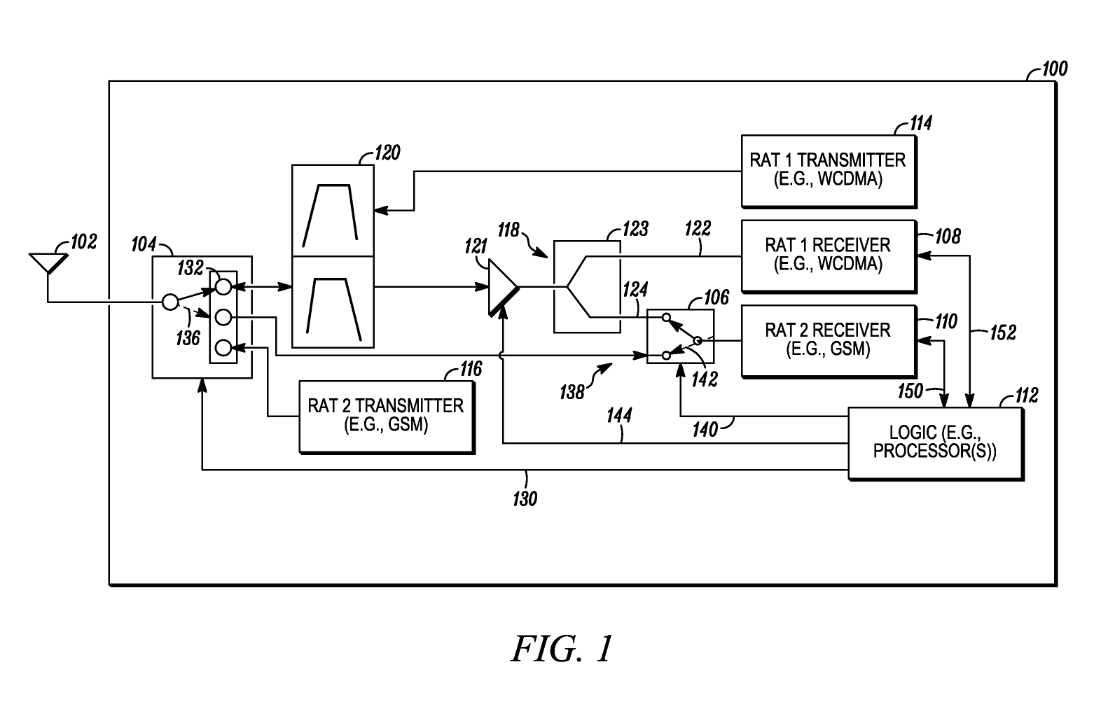

FIG. 1 illustrates one example of a wireless multimode radio access technology handheld device 100 which includes an antenna 102, a front end antenna transmit/receive switch 104, a radio access technology (RAT) bypass switch 106, a first wireless radio access technology receiver 108, such as a WCDMA receiver, a second wireless radio access technology receiver 110, such as a GSM receiver, logic 112 such as one or more microprocessors, microcontrollers or any other suitable structure, and corresponding radio access technology transmitters 114 and 116. The logic 112 may include memory (e.g. RAM, ROM etc.) that stores executable instructions that when executed cause a microcontroller to operate as described herein. Any other suitable structure may also be used including state machines, discrete logic or any suitable combination of hardware and software. The handheld device 100 may be, but is not limited to for example, a cell phone, a wireless email device, or any other suitable device that provides multimode co-band receiver operation.

The first and second wireless RAT receivers 108 and 110 when used in a multimode operation, use a shared signal receive path indicated as 118 that includes one or more shared receiver components 120, 121 and 123. In this example, shared receiver component 120 is a 3G duplexer, shared receiver component 121 is a low noise amplifier, and shared receiver component 123 is a signal splitter which as noted above and used herein includes couplers or any other suitable device for providing suitable signals 122 and 124 (or signal) for the first and second RAT receivers 108 and 110.

The handheld device 100 may provide simultaneous multimode reception using the shared receiver components 120, 121, 123 and first and second RAT receivers 108 and 110, if desired to provide quick handoffs and cell selections and provide other advantages when the handheld device is in a geographic area that includes base stations that transmit signals from different radio access technology transmitters.

The antenna transmit/receive switch 104 may be a conventional transmit/receive switch as known in the art which allows the handheld device 100 to suitably transmit and receive information via the antenna 102 using suitable antenna transmit/receive switch control information 130. As shown in this particular example, the antenna transmit/receive switch 104 is set to provide a received signal via the shared signal receive path 118 during, for example, a multi-RAT receive mode of operation. The antenna transmit/receive switch 104 also includes a switch port 132 which serves as a single mode bypass position as described further below. As also shown, the RAT bypass switch 106 is also set in a position to couple the second RAT receiver 110 to the shared receiver component 123, 121 and 120 when in a multi-RAT receive mode of operation.

The logic 112 generates the transmit/receive antenna switch control information 130 to control the antenna transmit/receive switch 104 to switch to a single RAT receive mode of operation by switching the transmit/receive switch 104 to the position shown by arrow 136 to couple the antenna 102 through a separate path 138 that bypasses the shared receiver components 120, 121, 123 and connects with the RAT bypass switch 106. In addition, the logic 112 also generates single RAT mode bypass switch control information 140 to control the RAT bypass switch 106 to switch to the position indicated by arrow 142 to complete the separate bypass path 138 to bypass the shared components 120, 121 and 123 when the handheld device 100 is in a single RAT receive mode. It will be recognized that the sequence of switching may be done in any suitable manner. The RAT bypass switch 106 has a first position that couples the second RAT receiver 110 to the one or more shared receiver components 120, 121, 123 and a second position that bypasses the one or more shared receiver components 120, 121, and 123. In this example, all three shared components are bypassed, but it will be recognized that if only a single shared element is used, the switch may be suitably located to bypass one shared receiver components. Accordingly as shown the RAT bypass switch 106 is interposed between the second RAT receiver 110 and the splitter shown as shared component 123.

The logic 112 controls the RAT bypass switch 106 and the antenna transmit/receive switch 104 to bypass the one or more shared receiver components 120, 121, and 123 if a single RAT receive mode of operation is desired using the second RAT receiver 110. The logic 112 also generates shared component disable information 144 which in this example is used to disable a shared component 121 in a multi-RAT receive mode. In this example, a low noise amplifier disable signal is used to disable to the low noise amplifier 121, such as putting it in a tri-state mode or removing power therefrom, to reduce current draw during a single RAT receive mode in response to the RAT bypass switch 106 being switched to a bypass position shown as arrow 142. It will be recognized that the single RAT mode bypass switch control information 140, the antenna transmit/receive switch control information 130 and shared component disable information 144 may be implemented by setting suitable bits in control registers, or may be provided in any other suitable manner.

The shared component 121 shown here as a low noise amplifier (LNA) has an input coupled to the antenna transmit/receive switch 104, in this example through a 3G duplexer, and an output that provides a signal to the signal splitter. As known in the art, the low noise amplifier amplifies a signal to overcome the loss introduced by the signal splitter. The amplifier may be used because of the use of the splitter. The signal splitter has an output that provides a signal 122 to the first RAT receiver 108 and another output that provides a signal 124 to the RAT bypass switch 106. Again, as noted above, the term signal splitter includes a coupler.

As also shown, the shared component 120, which in this example is a 3G duplexer, as known in the art includes suitable transmit and receive filters for WCDMA signals. Also, although not shown, the front end antenna transmit/receive switch 104 may also include suitable filters if desired and as known in the art. The RAT receivers 108 and 110 may be conventional RAT receivers as known in the art, similarly the RAT transmitters 114 and 116 may also be suitable transmitters as known in the art.

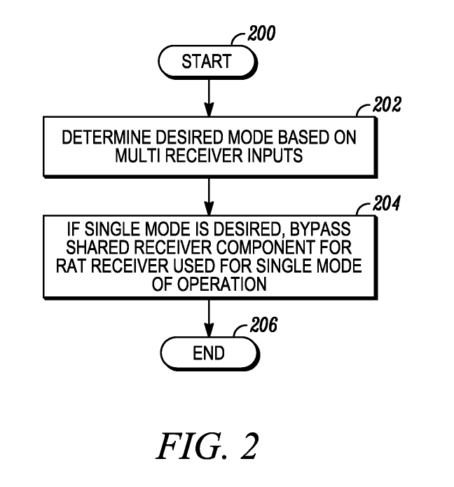

FIG. 2 illustrates one example of a method that may be carried out in devices such as device 100 or other suitable device that has a first and second radio access technology receiver that uses a shared signal receive path that includes at least one shared receiver component. As shown in block 200, the method begins, for example, after the handheld device 100 is turned on or any time after the handheld device is operational. As shown in block 202, the method includes determining if a single RAT receive mode of operation for the handheld device 100 is desired or a multi-RAT receive mode of operation is desired. This may be done, for example, automatically by the logic 112 or any other suitable structure or based on user input through a graphic user interface of the handheld device 110 in the event that the user wishes to operate in only a single RAT receive mode.

As shown in block 204, the method includes, if a single RAT receive mode of operation is desired, bypassing the at least one shared receiver component from a receive path such as path 138, for a corresponding RAT receiver used for the single mode of operation, shown in FIG. 1 as RAT receiver 110. As shown in block 206, the method may then be repeated as desired to, for example, automatically switch to a multi-RAT receive mode of operation or a single RAT receive mode of operation or wait until a determination as to the desired mode is made.

By way of example, the bypassing of the shared receiver component or components from a receive path includes controlling the RAT bypass switch 106 and the antenna/receive switch 104 to bypass the signal splitter shown as shared component 123 and the low noise amplifier shown as shared receiver component 121. In this example the duplexer 120 is also bypassed. However, it will be recognized that the shared receiver components may be interposed between the antenna transmit/receive switch 104 and the RAT bypass switch 106 or excluded therefrom depending upon the level of bypassing desired. In this example, as shown in FIG. 1, all three shared components are bypassed.

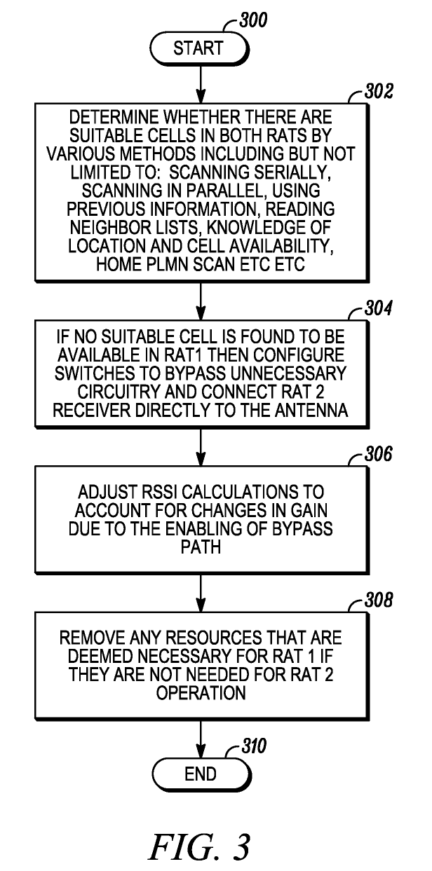

FIG. 3 illustrates another example of a method in accordance with one aspect of the disclosure. As shown, the method begins at step 300 which occurs, for example, after the handheld device is activated or at any other suitable time. As shown in block 302, as part of, for example, determining (e.g. by logic 112) if a single RAT receive mode of operation or a multi-RAT receive mode of operation is desired, the method includes determining whether there are suitable cells in both radio access technology areas by various methods including, but not limited to, scanning serially using the first and second RAT receivers 108 and 110, as controlled for example by logic 112 shown by communication links 150 and 152. These links also communicate the received information as provided by the respective RAT receivers 108 and 110 as known in the art. In addition, the logic 112 may control the first and second RAT receivers to scan cells in parallel, using previous information such as the last known suitable cell, reading neighbor lists, using knowledge of location and cell activity, using home PLMN scans, or any other suitable technique. For example, if the logic 112 during initial cell selection has no knowledge of surrounding cells, the logic 112 may optionally set the RAT bypass switch 106 and antenna/receive switch 104 to a multi-RAT receiver mode so that cell selection search can occur using both RAT receivers 108 and 110 in parallel. Alternatively, the logic 112 may switch the RAT bypass switch 106 and antenna transmit/receive switch 104 into a single RAT receive mode of operation so that only RAT receiver 110 is used and then switch the switches back to a multimode condition but only use the resulting signal information from the first RAT receiver 108 so that a serial cell selection technique is used.

When, for example, there is a saved neighbor list (as known in the art) the logic 112 looks to see if there are any first RAT receiver cells available such as WCDMA cells listed in the neighbor list. If so, the RAT bypass switch 106 and antenna/receive switch 104 are switched to provide a multi-RAT receive mode, if no saved neighbor list is provided then the logic 112 sets the RAT bypass switch 106 and transmit/receive switch 104 to provide a single RAT receive mode.

For example, as shown in block 304, the method includes that if no suitable cell is found to be available corresponding to a first radio access technology cell, then the logic configures the switching structures (104 and 106) to bypass unnecessary shared receiver components and connect the second RAT receiver 110 directly to the antenna transmit/receive switch 104. For example, if a signal strength provided by the first RAT receiver 108 does not exceed a desired threshold then the logic 112 may determine that no radio access technology cell is available in a given geographic location or position of the handheld device. The device then switches from a multimode receiving mode to a single RAT receive mode.

As shown in block 306, if necessary, the method may include adjusting receive signal strength indication (RSSI) calculations to account for changes in gain due to the enabling of the bypass path. For example, a difference in gain due to the bypassing of the shared receiver components 120, 121, and 123 may require, for example, a GSM receiver's automatic gain control (AGC) to be adjusted accordingly. As such, the method may include sending power control information to a radio access technology transmitter such as a base station in response to bypassing one or more shared receiver components to control a power level of incoming signals that are received by the second RAT receiver in response to activation of the RAT bypass switch 106 and/or activation of the antenna transmit/receive switch 104. As shown in block 308, the method includes bypassing the unnecessary shared receiver components from a receive path that are not needed for the second RAT receiver operation. As shown in block 310, the method may then be repeated as desired.

Also, during cell reselection the logic 112 may switch to the single RAT receive mode. When the network notifies the handheld device to decode WCDMA cells, for example, the logic 112 switches to the shared mode or multi-RAT receive mode before the next scheduled search frame on which the handheld device will perform a 3G cell decode. As noted above, since the shared RAT receive mode and single RAT receive mode may have different gains through their receiver front end paths, there may be a need to adjust automatic gain control. In the case where there is a difference in gain between the two modes, it may be desirable to store multiple sets of automatic gain control data. Another example may be to mathematically derive the automatic gain control compensation for measured gain differences. This may be done for example in the factory by measuring receive signal strength indications in both modes while applying the same signal to the antenna port. The difference in RSSI will be the difference in gain. This value can be used to adjust the stored AGC data before deciding on the AGC setting. A decision to apply the adjustment can be made in the same manner as the decision to decide which mode to select and corresponds to the specific selected mode.

As set forth above, the method includes determining the desired receive mode based on received information (e.g. signal strengths of received signals) as received by the first and second wireless access technology receivers by determining whether there exists a suitable cell which belongs to a first radio access technology with which the handheld device can communicate with. In addition, the logic may control the first and second RAT receivers 108 and 110 to either simultaneously receive incoming signals or sequentially receive incoming signals to determine if a single RAT receive mode of operation is desired. As also noted above, during a cell reselection operation, the logic 112 may control the RAT bypass switch 106 and the antenna transmit/receive switch 104 to disconnect the first RAT receiver 108 and connect the second RAT receiver 110 to receive the incoming signal from the antenna 102 to provide a single RAT receive mode and switch back to a multi-RAT receive mode before a next scheduled search frame is used to perform a cell decode operation.

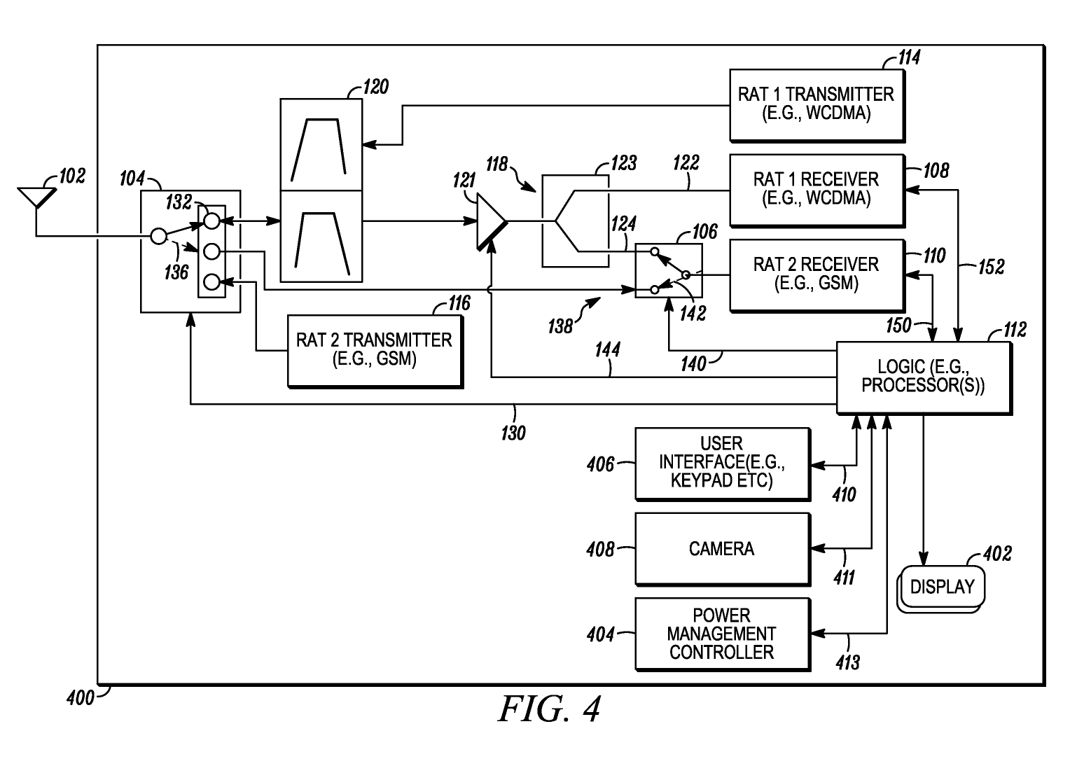

FIG. 4 illustrates one example of a handheld device 400. In this example, the handheld device 400 shown is a cell phone and as noted above, is not shown to include conventional circuitry such as cell phone telephone circuitry and other circuitry as known in the art. In this example, in addition to the components shown in FIG. 1, the device 400 also includes one or more displays 402, and a power management controller 404 operative to save power due to the limited battery power available, one or more user interfaces 406 such as a keypad pointing device or any suitable user interface, and an image capture circuit 408 such as a camera. The logic 112 is suitably coupled to each of the elements shown by arrows 410, 411 and 413 as known in the art. In addition, it will be recognized that with respect to FIGS. 1 and 4 that multiple RAT receivers and transmitters may be employed in the device depending upon the systems that the device is intended to communicate with.

Among other advantages, where for example one RAT receiver is for a GSM system and another RAT receiver is for a co-band WCDMA system, a separate GSM only mode is selected when there is no need to do WCDMA decoding. The GSM only mode removes, for example, a low noise amplifier or other components to reduce current drain and removes front end loss introduced for example by a splitter or a 3G duplexer which can result in improved sensitivity. In one example, a direct receive path is switched in and a shared receive path is bypassed when the device is in a GSM only mode. Other advantages will be recognized by those of ordinary skill in the art.

The above detailed description of the invention and the examples described therein have been presented for the purposes of illustration and description only and not by limitation. It is therefore contemplated the present invention cover any and all modifications, variations, or equivalents that fall in the spirit and scope of the basic underlying principles disclosed above and claimed herein.

What is claimed is:

1. In a device having a first radio access technology (RAT) receiver and a second RAT receiver that use a shared signal receive path that includes at least one shared receiver component, a method comprising:
determining if a single RAT receive mode of operation or a multi-RAT receive mode of operation is desired; and
if a single RAT receive mode of operation is desired, bypassing the at least one shared receiver component from a receive path for a corresponding RAT receiver used for the single mode of operation.

2. The method of claim 1 wherein bypassing the at least one shared receiver component from a receive path for the corresponding RAT receiver used for the single mode of operation comprises bypassing at least a signal splitter that provides received information into a first signal and a second signal for the first and second RAT receivers, a low noise amplifier and a duplexer.

3. In a device having at least a first radio access technology (RAT) receiver and a second RAT receiver that use a shared signal receive path that includes at least one shared receiver component, a method comprising:
determining a desired receive mode based on received information that is received by the at least a first and second RAT receivers; and
if a single receive mode of operation is desired using the second RAT receiver, control a RAT bypass switch and at least an antenna transmit/receive switch to bypass at least one receiver component associated with the first RAT receiver.

4. The method of claim 3 wherein determining the desired receive mode based on received information that is received by the at least first and second wireless radio access technology receivers comprises simultaneously receiving information by the first and second wireless RAT receivers and controlling the RAT bypass switch and antenna transmit/receive switch to bypass at least a low noise amplifier used to amplify received information for the first RAT receiver.

5. The method of claim 3 wherein the at least one bypassed receiver component comprises at least one of: a WCDMA duplexer, a signal splitter and a low noise amplifier operative to amplify the first signal for the first RAT receiver.

6. The method of claim 3 comprising sending power control information to a RAT transmitter in response to bypassing the at least one receiver component of the first RAT receiver to control a power level of the incoming signal that is received by the second RAT receiver in response to activation of the radio access technology (RAT) bypass switch.

7. The method of claim 3 wherein determining the desired receive mode based on received information that is received by at least first and second wireless radio access technology receivers includes determining whether there exists a suitable cell which belongs to a first radio access technology with which the hand held device can communicate with.

8. The method of claim 4 comprising turning off power to the low noise amplifier used for the first RAT receiver in response to bypassing the low noise amplifier.

9. The method of claim 3 further comprising controlling the first and second RAT receivers to either simultaneously receive incoming signals or sequentially receive incoming signals to determine if a single RAT receive mode of operation is desired using the second RAT receiver or a multi-RAT receive mode of operation is desired.

10. The method of claim 3 comprising, during a cell reselection operation, controlling the RAT bypass switch and antenna transmit/receive switch to disconnect the first RAT receiver and connect the second RAT receiver to receive the incoming signal from an antenna to provide a single RAT receive mode and switch back to a multi RAT receive mode before a next scheduled search frame is used to perform a cell decode operation.

11. A wireless multimode radio access technology (RAT) handheld device comprising:
at least an antenna transmit/receive switch operatively coupled to an antenna;
at least first and second wireless radio access technology (RAT) receivers, operatively coupled to the antenna transmit/receive switch, that use a shared signal receive path that includes at least one shared receiver component;
a RAT bypass switch, operatively coupled to the second RAT receiver and to the antenna transmit/receive switch, with a first position operative to couple the second RAT receiver to the at least one shared receiver component and a second position operative to bypass the at least one shared receiver component; and
logic operative to control the RAT bypass switch and the antenna transmit/receive switch to bypass the at least one shared receiver component if a single RAT receive mode of operation is desired using the second RAT receiver.

12. The wireless handheld device of claim 11 wherein the at least one receiver component comprises a WCDMA duplexer, a low noise amplifier and a signal splitter, the amplifier having an input operatively coupled to the antenna transmit/receive switch through the WCDMA duplexer and an output operatively coupled to the signal splitter, the signal splitter having a first output operatively coupled to the first RAT receiver and a second output operatively coupled to the RAT bypass switch.

13. The wireless handheld device of claim 11 wherein the logic is operative to provide a single RAT receive mode by at least generating single RAT mode bypass switch control information to control the RAT bypass switch, generate antenna transmit/receive switch control information to control the antenna transmit/receive switch to switch to a single RAT receive mode of operation and generate shared component disable information to disable the shared component used in a multi-RAT receive mode.

14. The wireless handheld device of claim 11 wherein the logic is operative to generate power control information for a base station in response to controlling bypassing of the receiver components of the first RAT receiver to control a power level of a received signal that is received by the second RAT receiver in response to bypassing the at least one receiver component associated with the first RAT receiver.

15. The wireless handheld device of claim 11 wherein the logic is operative to determine a desired RAT receive mode based on received information that is received by the at least first and second wireless radio access technology receivers via different radio access technology transmitters by determining whether a current cell is a suitable cell to camp on.

16. A wireless multimode radio access technology (RAT) handheld device comprising:
at least an antenna transmit/receive switch operatively coupled to an antenna and including a single RAT mode switch operation;
at least first and second wireless radio access technology receivers;
a low noise amplifier (LNA) and a signal splitter, the amplifier having an input operatively coupled to the antenna transmit/receive switch through a WCDMA duplexer and an output operatively coupled to the signal splitter, the signal splitter having a first output operatively coupled to the first RAT receiver and a second output;
a radio access technology (RAT) bypass switch, operatively coupled to the antenna transmit/receive switch, to the second output of the signal splitter and to the second RAT receiver; and
logic operative to control the RAT bypass switch and at least the antenna transmit/receive switch to bypass the amplifier and signal splitter if a single RAT receive mode of operation is desired using the second RAT receiver.

17. The wireless handheld device of claim 16 wherein the logic is operative to provide a single RAT receive mode by at least generating single RAT mode bypass switch control information to control the RAT bypass switch, generate transmit/receive antenna switch control information to control the antenna transmit/receive switch to switch to a single RAT receive mode of operation and generate amplifier disable information to disable an amplifier used in a multi-RAT receive mode of operation.

18. The wireless handheld device of claim 16 wherein the logic is operative to generate power control information for a base station in response to controlling bypassing of the receiver components of the first RAT receiver to control a power level of a received signal that is received by the second RAT receiver in response to bypassing the amplifier and signal splitter.

19. The wireless handheld device of claim 16 wherein the logic is operative to determine a desired receive mode based on received information that is received by the at least first and second wireless radio access technology receivers via different radio access technology transmitters by determining whether a current cell is a suitable cell to camp on.
